(19) United States
(12) Patent Application Publication
(10) Pub. No.: US 2002/0113909 A1
(43) Pub. Date: Aug. 22, 2002

(54) Methods and devices for alternative designs of interior space

(76) Inventor: Jeffrey Sherwood, Woodstock, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/080,102

(22) Filed: Feb. 21, 2002

Related U.S. Application Data
(60) Provisional application No. 60/270,420, filed on Feb. 21, 2001.

(51) Int. Cl. H04N 5/66

(52) U.S. Cl. 348/739; 348/778

(57) ABSTRACT

Systems and methods for changing the visual appearance of an interior space using computer-controlled devices. The computer-controlled devices include a number of video display screens arranged about the interior space to display a series of video images. Several speakers are placed proximate to each video display screen to project ambient sounds associated with the video images being displayed on the video display devices. Several scent generators dispense a scent associated with at least one video image displayed on the video display screens. A central processing unit controls and coordinates the operation of each of the computer-controlled devices to present a multimedia presentation that alters the appearance of the interior space.

### CROSS REFERENCE TO RELATED APPLICATIONS

This application claims priority from provisional application, serial No. 60/270,420 filed Feb. 21, 2001.

### FIELD OF THE INVENTION

The present invention is directed to methods for altering interior spaces using multimedia and other sense-stimulating methods. In particular, interior spaces are controlled using environmental methods and computer programs having the capability of rapidly changing the immediate perception of the space.

### BACKGROUND OF THE INVENTION

Retailers of all types traditionally change interior spaces in order to attract customers. During such changes, the space is generally unusable until all changes have been made. This leads to a loss of customers and loss of money due to the inability to use the space. If enough interest can be generated in customers who are curious about the changes, and who then flock to the newly changed and reopened space, the change has a positive effect on the business. On the other hand, while the change is occurring in one site, customers may learn of new retail outlets and never return to the original space. In that case, the change has had a negative effect on the business.

One of the most fickle markets to operate in is the restaurant business. Restaurants have tried many methods to attract and keep customers, but many newly opened restaurants close because customers are initially attracted to the restaurant, but only return there until another newer restaurant opens. One approach many restaurants have tried to keep customers is to have a theme.

There are many theme restaurants in the United States. Some have been very successful, many have not. These restaurants typically have menu, décor, and a style of operation that reflect the theme. Designing the initial theme is the crucial element in starting the restaurant and changing it involves a complete redo of the space, menu, training regimens for staff and a change of will on the part of the business. All of these are major hurdles for a business to overcome.

There is a limited number of changing theme restaurants. Cities in Washington, D.C. is one. For a while, it reflects one international city in food and décor, and then it will redo itself to look like another international city. It closes about every 6 months and while closed, totally redoes the interior décor by repainting, repositioning items in the restaurant and bringing in new décor items. Cities is very popular and the fact that its diners know in advance exactly when it is closing for remodeling makes standing room only crowds at Cities a common occurrence.

A major problem for any themed space is that customers can become accustomed to, and bored with, the theme. Even very popular restaurants lose business due to diners' boredom with the same kind of choices at a theme restaurant. There are definite trends for kinds of restaurants and a business can fail because it is not part of the trend. For example, in upscale dining, steak houses have been in and out of style several times in the past few decades. Even highly successful gourmet houses have to periodically change decor to keep customers coming back. What is needed are retail spaces, such as restaurants, that can change the theme of the space without a lot of time when the space is unusable, and the change occurs in many different areas of the business, such as the interior space, the menus and the chef.

Restaurants are not the only retail space that needs to stay ahead of customer attenuation. Every retail site needs to continue to attract new customers while satisfying the needs of old customers. Many large retailers have met this need by designing their stores as warehouses or using minimalist design, in essence, making lack of design their design. This method may help in sending the message to customers that no money is being spent on space so that there are more savings in the price of the merchandise. Unfortunately, these designs do not attract customers and do not stimulate them to buy more items. What are needed are methods for designing and easily redesigning retail spaces that are stimulating to customers and help create a buying atmosphere.

Retail space is not the only space where boredom creeps in. People spend enormous amounts of time and money moving from home to home, or remodeling existing structures. Home design is very thematic and trends in colors or space utilization fluctuate. What is needed are methods of changing the living spaces of people that are easily changed or can become thematic for different seasons or occasions.

### SUMMARY OF THE INVENTION

The present invention solves the problems cited above by providing systems and methods for changing the visual appearance of interior spaces. Generally described, a system according to an embodiment of the invention provides a combination of computer-controlled devices and interior design elements to create an appearance for an interior space. More particularly described, the system contains a number of video display screens arranged about the interior space to display a series of video images. The system also contains a number of speakers placed proximate to each video display screen to project ambient sounds associated with the video images displayed on the video display devices. Additionally, the system contains a number of scent generators that dispense a particular scent associated with at least one video image displayed on the video display screens. Finally, the system contains a central processing unit the controls and coordinates the operation of each of the computer-controlled devices to present a multimedia presentation that alters the appearance of the interior space.

The system may also contain a number of lighting elements that are controlled by the central processing unit to mimic the lighting conditions of an environment displayed in the video images to further alter the appearance of the interior space.

The central processing unit may also receive broadcast signals, such as satellite, cable and television broadcast signals, and display the broadcast signals on at least one of video display screens.

The system may also contain a number of stage prop elements that are placed in predetermined positions within the interior space to complement the video images and further alter the appearance of the interior space.

The present invention also includes methods for altering the appearance of an interior space by electronically displaying an environmental scene on a series of video display screens. For example, the present invention can be used in restaurants, in retail shopping spaces, in convention settings, in residential homes, and in public spaces. There is no limitation on the sites where such methods and devices can be applied.

The method begins by installing a number of computer-controlled devices within the interior space. The computer-controlled devices include, but not limited to, plasma display screens to electronically display the environmental scene, speakers placed proximate to the plasma display screens to play ambient sounds associated with the video images, scent generators that dispense a scent associated with the video images, and lighting banks. Once the computer-controlled devices are installed, a digital environmental scene is produced that can loaded into the computer-controlled devices to alter the appearance of the interior space. The production of the environmental scene includes capturing a number of digital video images and digitally recording the ambient sounds of the particular environment.

Next, the video images and ambient sounds are stored on a local database on a local server. The images are uploaded to a central processing unit over a distributed network, such as the Internet.

### BRIEF DESCRIPTION OF THE FIGURES

FIG. 1 is a schematic of an embodiment of the computer-controlled elements combined to alter the appearance of an interior space.

FIG. 2 is a schematic drawing illustrating a layout of restaurant using the present invention to alter the appearance of the interior space.

FIG. 3 is a logic flow diagram illustrating a method for electronically altering the appearance of an interior space.

### DETAILED DESCRIPTION OF THE INVENTION

The present invention is directed to systems and methods for electronically changing the design of interior spaces. In particular, the present invention is directed to systems and methods for changing the appearance of an interior space quickly and efficiently, using interchangeable elements that are connected to and driven by computers. Such elements include computer-assisted devices such as multimedia display screens, lighting elements, audio systems and olfactory devices. The systems also includes stage prop devices the may be easily place at predetermined positions within the interior space to further enhance the appearance.

An exemplary embodiment of the present invention comprises a system for creating an interior space and methods of doing business in such a space. The system comprises a multi-sensory experience created by the ability to change visual effects, lighting, sound and even smells through software-driven computer devices such as video display screens, lighting elements, audio systems, and scent generators. With installation of state-of-the-art video displays, lighting grids, digital audio and air treatment equipment all controlled and coordinated by a central processing unit and a digital controller, any interior space can be programmed to change its look and feel almost instantly.

The system combines the software driven elements with traditional interior design elements. For example, in combination with the computer-controlled devices, the present invention uses stage prop elements typically used in the motion picture industry, such as knickknacks, wall decorations, even interior landscaping including plants, flowers, sand and rocks. All of these elements are designed to be easily interchanged or altered. For example, many of the stage prop elements, such as large plants and furniture are placed on wheels so that they may be added to or removed from the interior space quickly and easily.

One embodiment comprises multiple computer-controlled devices including but not limited to, visual displays screens, lighting grids, audio systems and sound design, scent generators, and a central processing unit that contains digital control systems and software. These elements can be used in any combination with each other and with any other elements that can be used to add to an environment to create a particular atmosphere.

Video images associated with the environment are displayed by a number of visual display screens. In one embodiment, plasma display screens are capable of reproducing high-definition visual images that are so life-like that viewers, at first glance, will believe they are seeing the real thing are used to display the video images. These screens can be used to display high definition thematic video to become “windows on the world” that virtually transport the viewer almost anywhere. The video display screens are designed into the interior space so that the screens appear to be windows to give the effect of being inside looking out on the selected environment scene being displayed by the video. The video screens are positioned around the interior space soothe the entire space covered in one or more screens so that the illusion of a part or the entire interior space is created using such audiovisual devices and computer control.

In conjunction with the video images, there are lighting aspects of the interior space. The lighting in any retail space is a major factor in creating ambiance. Most retail spaces are lit with standard fluorescent lighting that is hard on the eyes and unflattering to the people and products contained within the space. The central processor controls the at least a portion of the lighting of the interior space and is coordinated with the video images. For example, a retailer featuring products for the beach, such as swimwear, could display video images on a number of video display screens situated around the store to create the illusion to their customers that they are staring out onto a beach somewhere in the Caribbean. The retailer could use lighting elements equivalent to natural outdoor lighting thereby adding to the buyer's experience of feeling that they are actually at the beach. Additionally, the use of neon or other novel lighting techniques, such as washing a wall in flamingo pink and sea green lighting, to further increase the customer's enjoyment of an entertainment experience.

The system also includes a number of audio systems and sound designs. Retailers know that background music is important in creating an environment conducive to buying; however, most take very little care in determining what is played. Many subscribe to music services that provide tapes, which run continuously. Others use systems that employ commercial radio stations to provide the music background. The audio system includes a number of primary speakers for providing the ambient sounds associated with the video images of the environment being display on the video screens. These methods include choosing sound to fit the theme of the environment being displayed. Typically, two primary speakers are placed proximate to each video display screen to play the ambient sounds. The primary speakers are coordinated with the video screen display to play sounds associated with a particular image within the video images as they move from one video screen to another. As the particular image moves from one video display screen to another, the ambient sound associated with that particular image is played on the corresponding primary speakers. This allows the ambient sound to “follow” the image, thereby creating the illusion of motion.

The system also includes a number of auxiliary speakers that play sounds that complement the environment being displayed in the video images. The auxiliary speakers are positioned within the interior space to surround or “bathe” the customer in the particular sound. For example, Caribbean music may be played when the environment displayed by the video image is a beach scene. The Caribbean music compliments the ambient sounds of the surf and wind and heightens the psychological impact on the customer. Different forms of music create different moods, for example, Baroque music has been shown to accelerate learning.

The system also includes scent generators that dispense certain scents associated with the particular environment being displayed by the video images to stimulate the olfactory senses of the customer. The scent generators are placed around the room to insure that the entire interior space is covered when the scent is dispensed. Scientific studies have shown that the sense of smell makes an impact on memory. Virtually everyone has experienced smelling an aroma that was reminiscent of a particular place or time, such as from childhood, the smell of the ocean at the beach, the smell of Mom's pumpkin pie at Thanksgiving, popcorn at a movie theater, or hot dogs at a ballpark. Thus, not only is the particular scent important, but the also the timing of the scent in relation to the visual image is equally important. Therefore, the scent generators may be programmed in two modes. The first mode is designed to release the scent at time intervals to insure that the scent remains constantly in the air. This may be used for dispensing scents reminiscent of the beach when displaying a beach scene. The second mode is designed to have the scent generator release a particular scent in coordination with a particular image being displayed. For example, when displaying a European city scene, the scent generator can release the scent of freshly cut flowers as a flower cart passes through the scene.

Restaurants have learned that the smell of good food has a powerful effect on its customers. Many fine dining establishments have moved their kitchens out front near the dining patrons. They found the more appetizing the food smells, the better the business. Any establishment can benefit from themed aromas that are used in creating a selected environment. By integrating the sense of smell into the experience, customers will be creating memories that will bring them back to the establishment again and again.

In addition to the computer-controlled devices the system may also incorporate stage prop elements that are easily transported into and out of the interior space to add to the realism of the environment. Such elements include, but are not limited to staging materials and devices, props, plants, flowers, shrubs, rocks, sand, furniture, pictures, draperies, and any other design elements that can be used to complete the atmosphere of the environment. For example, in the environments of the present invention, specific interior areas are designed with areas designated for props. When a theme changes, methods for changing include wheeling in pre-designed carts of props and putting them in their predetermined place. The previous displays are wheeled out and the changeover is complete. The present invention comprises such movable transport elements and the elements that are contained on or within the movable transport elements. The same methods may also be used for wall and window treatments.

Not only are props and other inanimate objects used in the selected environments for creation of an atmosphere, but also living biological organisms can be added for effect. Such organisms can include plants or animals, or any elements that can comprise interior landscaping. Plants, flowers, shrubs, fish, birds, and animals are powerful tools in creating an air of realism in an environment. They not only add to the “feel” of the space, the scents they give off can be a major part of the olfactory element.

The system also includes a central processing unit to control the visual displays, audio and lighting systems, and the scent generators. The central processing unit uses software application programs that combine the elements of visual images, lighting and sound data. The visual images include an encoded to signal that determines when the appropriate sounds are played and when the scents are released in coordination with the visual images. As the visual images changes in the environment, the sound and lighting adjust accordingly to remain synchronized with the visual images.

The present invention may be employed in a variety of industries. For example, the present invention is well suited for creating interior spaces in restaurants that are capable of creating a selected environment that is multifaceted and easily changeable. Though the example given here for a restaurant embodiment, the elements presented can be used with any interior space. This innovative restaurant embodiment comprises combining cutting edge media technology to create a selected environment with methods for employing world class, Master Chef cooking ability that is constantly changing. This embodiment solves one of the biggest problems in retail food service, the “honeymoon” effect. Simply put, new restaurants open to standing room only crowds, only to see them dwindle away over time. This common restaurant problem is created by the public's desire for new and different experiences.

The system for retail food services uses an interior design and environmental control technology that allows for rapid redesign and remodeling of a restaurant's decor and theme. Additionally, new chefs are brought in to cook in a showcase method and style, so that not only are the surroundings changing, the food and chef are also new. The diner is presented with new experiences on a regular basis, and thus, the desire for change is met.

Not only is the actual experience available to customers, the present invention integrates with the restaurant's activities with Internet access. The activities of the chef can be broadcast, either on means such as television or radio, or the Internet. Persons can participate in the dining experience via virtual means, such as view the live action, obtain information about the chef, recipes, order ingredients, or menu items, suggest menu items or wine selections, or participate in every way possible without actually being present. The same information and experience can be provided at any time through the provision of media such as digital capture, videotaping or filming, books, articles, or websites.

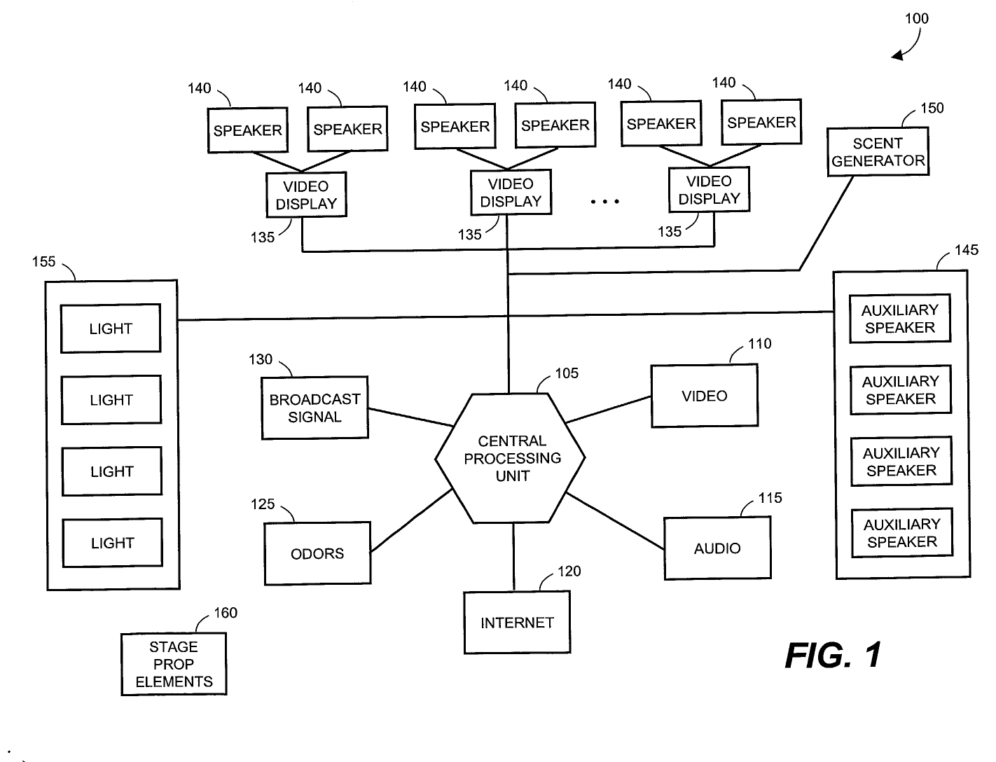

The interior design of a preferred restaurant embodiment comprises a fully automated, state-of-the-art, computer controlled audio-visual system that powers super resolution plasma screen video “windows”, mood setting professional lighting grids, concert hall quality sound, broadcast and Internet video capabilities, high definition projection screens and other atmospheric effects. The methods and devices of the present invention allow for changes in theme and mood of an interior space in minutes, vs. months for normal renovations. This flexibility gives a preferred restaurant embodiment a number of key advantages. Boredom ceases to exist because every visit to a preferred restaurant embodiment is unique. Companies needing strong audio-visual support for meetings have it in abundance. Current events can be capitalized on, such as sporting events, holidays, trade shows, reunions, etc. Featured changes in menu can now be fully supported environmentally. For example, Caribbean seafood is served in a tropical beach setting, Classical French cuisine on the Left Bank of Paris, and Elk in a Rocky Mountain Ski Lodge. The combinations of theme restaurants with the methods and devices of the present invention are multiple. See FIG. 1 for an embodiment of the electronic and computer-driven aspects of the present invention.

Not only are the multimedia elements changeable, at least some, if not all, of the surrounding interior design elements are changeable. It is preferred that each element is modularized for easy movement. Plants, wall decorations, bric-a-brac, table settings, even tabletop design is all modularized for quick turnaround. These items can be supplied under yearly contract by nurseries, prop houses, antique stores, picture shops, or other retail establishments. In a small amount of time, such as an hour, these surprisingly affordable, portable items can be completely changed. For example, changing the featured menu items from seafood to southwestern cuisine is easily accomplished by wheeling in cactus and desert wildflowers, and wheeling out palm trees and orchids.

The present invention may also be used for showcasing a particular chef or cooking style for a selected amount of time. The activities of the chef or chefs can be captured by attending the restaurant or by other means such as Internet viewing, electronic interaction or by video, audio or printed means. Chefs could be found in cooking schools or well known chefs can be used as star chefs to be featured at the restaurant.

One way of discovering and promoting new culinary talent is to showcase the cooking skills of new or emerging chefs or styles of cooking. The public has not seen this system of discovering, evaluating and displaying talent. Cooking and cooking shows are a popular type of entertainment and the present invention comprises incorporating such entertainment in a restaurant setting.

In the United States alone, dozens of Culinary Arts Schools graduate thousands of qualified new chefs each year. The methods of the present invention comprise bringing together a number of qualified young chefs to audition and select the “cream of the crop.” In addition, the widespread exposure created by the methods of the present invention will draw young talent from other areas of the food services industry. This will serve to further increase the size of the audition pool.

For example, this restaurant embodiment can showcase one new chef every 6-8 weeks. Each showcase will last one to four weeks depending upon the chef's availability, popularity of his or her showcased creations, facility commitments, and other considerations. Not only will the showcase chef cook in the restaurant, but he or she will also provide training for both in-house staff and others who may attend a cooking school. In between showcases, the preferred embodiment comprises methods of creating a restaurant comprising a world-class executive chef with operational support and customer service staff. There will be a house haute cuisine menu that is regularly augmented with the most popular selections of previously showcased chefs. The in-house staff will be well qualified to prepare these selections because of the hands on training they received in assisting the showcase chef. These dishes will be attributed to that chef, creating ongoing public recognition of his or her creations.

With computerized order systems, the popularity of each dish is regularly evaluated. As selections lose popularity they are dropped from the menu and replaced with the later showcase hits. This process creates an ever evolving “menu by acclaim” and will establish the present embodiment as a place that offers the newest best of the best.

A preferred showcase method comprises various elements that can be combined in multiple ways. These elements include, but are not limited to, finding new talent; talent auditions; interior design and environmental support; showcase promotion and preparation, the showcase and post showcase marketing and media interactions.

Preferred methods of finding new talent include affiliation with culinary institutes and advertising for auditions in trade journals. A most preferred and efficient way is through an affiliation with one or more of America's leading Culinary Arts Schools. This scenario provides a substantial talent pool for the embodiments of the present invention and media exposure for the schools. This assists the schools in their on going enrollment activities. A second method is a general industry wide search, featuring a press release campaign through food service industry publications. This method allows for finding less classically trained chefs, who through experience have become masters of their trade in somewhat more obscure circumstances.

An additional component of the present invention comprises selection of the showcase chefs. From applicant resumes and recommendations, a pool of 5 to 6 young chefs is selected to audition. This selection is done 6-8 times per year. Every selected chef submits a proposed menu. An evaluation committee preferably composed of an owner, the in-house executive chef, master chef advisory board member, and a culinary school instructor, selects 1 to 2 dishes from the submitted menu for preparation by the auditioning chef. The evaluation committee then chooses one or more young chefs for a future showcase.

An important element of the showcase embodiment is providing an environment that promotes maximum exposure of the food, talent and personality of the chef and that entertains the dining patrons. The flexible environment created by the methods and devices of the present invention support the theme of the food showcased. Through adjustments in the interior décor, as described herein, such as lighting, visuals, sound, music, props, bric-a-brac and other elements, patrons will “feel” they are enjoying these taste creations in their original and natural settings.

The present invention can also be used for highlighting and promoting the showcases. One embodiment comprises using the first night of a showcase as a dress rehearsal night that can be used for charity fundraisers, or other civic or charitable events. For example, at the start of each showcase, a preview night is held to which VIP guests are invited. The featured chef selects a recognized charity and the invited guests are asked to donate to this charity a sum proportionate to the degree that they enjoyed the chef's presentation. This VIP evening positively contributes to the welfare of the community by raising substantial charitable contributions. In addition, it provides a benchmark by which a young chef's popularity can be evaluated. It also helps determine any serious shortcomings, allowing for adjustments prior to the full showcase.

A most preferred embodiment of the restaurant embodiment of the present invention comprises the interior design feature comprising a performance cooking stage. Although the majority of food preparation and execution will occur in the main kitchen, it is on this stage that the guest chef gets to showcase his or her talents. For example, the stage can feature a broadcast video system that is projected onto two, 12 foot, high definition screens giving the dining patrons of the restaurant embodiment a bird's eye view of the young chef in action. In addition, restaurant embodiment features a professional audio system that gives the chef the ability to communicate with the audience. Additionally, this stage can be linked to outside media sources or the Internet for live broadcast or interaction with others by electronic means.

The high-end video component of the restaurant embodiment is useful for web casting. Gourmet food fans and reviewers across the nation see and appreciate the skills and creative talents of young talent. Regular promotion in food-related publications and press releases to the national consumer media will alert food connoisseurs across the country to the showcases. In addition, all items showcased can be purchased through a joint venture with an established Internet gourmet foods company. With this, the ingredients and foodstuffs necessary for repeating the menus are available for consumers to attempt these featured menu items at home, or to buy already prepared selections. All video captured is archived for further use. Such video can be edited for a broadcast cooking show featuring young chefs.

Although the present invention has been described in relation to restaurants and food services, those skilled in the art will appreciate that the present invention may be applied to any space to create a particular environment. For example, the system may be used in cinemas and motion picture theaters, particularly in specialty restaurants themed to current and upcoming movie titles; corporate training and development sessions, used for uniting multiple national locations in an ultimate teleconference experience; in hotels and in hotel rooms, restaurants and meeting facilities; convention facilities; for state-of-the-art multi-media rooms for business and educational meetings; retail stores in state-of-the-art display areas for department stores, clothing chains, automotive, sporting goods, to display items for sale or to set a mood or to attract customers into the store with an interactive environment; service businesses, such as travel agencies or real estate; and for general consumers, for example for ultimate family home entertainment centers for discriminating buyers. The preceding examples are for illustration only and are not to be seen as limiting the scope of the present invention.

References will now be made in detail to this invention which are illustrated in the accompanying drawings. Wherever possible, the same reference numbers will be used throughout the drawings to refer to the same of like elements.

FIG. 1 is a block diagram illustrating a computerized design system 100 for altering the look and design of an interior space. The computerized design system 100 may be used to create a theme within a specific design space, such as a restaurant or retail store. The computerized design system 100 contains several computer-controlled devices, whose operation is controlled and coordinated by a central processing unit 105, which includes a digital controller, such as a Crestron digital controller, model number TPS-6000, manufactured by Crestron Corporation of Rockleigh, N.J. The digital control controls and coordinates the outputs to the various computer-controlled devices. The processing unit 105 receives a variety of input signals from various sources, combines the input signals into a coherent multi-sensor presentation. Specifically, the processing unit 105 receives a video signal 110, an audio signal 115, images, and sounds over the Internet 120, odors 125, and broadcast signals, such as satellite, cable, and television signals.

The signals are combined into multimedia display and output to the computer-controlled devices through the digital controller. The video images are sent to several video display screens 135 positioned around the interior space. The video display screens 135 are typically flat-panel, high-resolution plasma displays that are capable of displaying high-resolution thermatic video, such as the 42″ 42B-1 plasma display manufactured by the Sony Corporation of America, New York, N.Y. Although the preferred embodiment uses plasma display screens, those skilled in the art will appreciate that any video display screens that are capable of displaying digital video images may be used without departing from the scope of the invention.

Each video display screen 135 is arranged as a “window,” which creates the illusion to a individual standing in the interior space that they are looking upon a particular outdoor environment. For example, the video display screens 135 may display a high-resolution video of an ocean as viewed from a beach. This creates the illusion to the viewer that they are located on a tropical island looking out at the ocean. To further enhance this effect, the video display screens 135 may be framed as actual windows. This further enhances the customer illusion that they are positioned inside a building looking out on a particular environment.

The number of video display screens 135 used to create the multi-sensor display varies on the size and shape of each interior space. However, there are several guidelines to maximize the visual experience for the customer. First, the video display screens 135 should be arranged to ideally provide at least 270 degrees of visual coverage. This requirement is usually driven by the fact that the environments that will typically provide this service, such as restaurants and retail outlets, have a storefront that is unsuitable to support the video display screens. This leaves the three remaining walls for placement of the video display screens 135. Although, the preferred embodiment uses video display screens to provide at least 270 degrees of video coverage in the interior space, those skilled in the art will appreciate that other configuration of video display screens 135 that provide less than 270 degrees of coverage or provide more than 270 degrees of coverage may be used without departing from the scope of this invention.

Second, since the video display screens 135 are being presented as “windows,” the placement of the video display screens 135 should mimic the placement of real windows as closely as possible. Therefore, the video display screen 135 should be positioned in accordance with applicable building codes for the positioning of windows along a given wall. Typically, the applicable building codes require that a commercial building have at a minimum, a window placed every eight (8) feet along a given outside wall. Therefore, the video display screens 135 should be spaced about every eight feet along a given wall within the interior space. However, this is only a starting point for the placement of the video display devices 135. The size and shape of the overall interior space, as well as the size of the video display screens 135 must be taken into account when planning the layout of the video display screens 135. For instance, in small interior design spaces, placing a video display device every eight feet may look awkward and cramped. In this instance, it may be more visually appealing if the video display screens 135 were placed greater than eight feet apart. Although the primary use of the video display screen 135 will be positioned on the walls of the interior design space, the video display screens 135 may also be placed on the ceiling to display images of the sky or an overhead scene to further enhance the visual experience.

In addition to the video display screens 135, the computerized design system 100 also has a three dimensional (3-D) audio system consisting of primary speakers 135 and auxiliary speakers 145. The primary speakers 135 are connected to the video display screens 135 and are coordinated to project the ambient sound associated with the video currently displayed on the particular video display screen 135. Normally, in the preferred embodiment, there are two (2) primary speakers 140 associated with each video display screen 135. The two primary speakers 140 digitally replicate the ambient noises associated with the current environment displayed on the particular video display screen 135. As the video image moved from one video display screen to another, the ambient sound follow the image and is projected from the speakers 140 connected to the video display screen 135 in which the image is displayed, thereby creating the illusion of motion. For example, a beach scene typically contains the sounds of waves crashing against the shore, rustling palm trees, and birds. These sounds are output by the primary speakers 140 and convey a sensation of movement to the patron. For instance, a seagull within a beach environment may be shown flying across the beach. As the image of the seagull moves from one video display screen 135 to another, the sound associated with the seagull is projected from the primary speakers 140 associated with that particular video display screen 135. Thus, the coordinated display of the seagull image and the sound, across the video display screens 135 and associated primary speakers 140 present the illusion of motion, just as it would be observed on the actual beach.

In addition to the primary speakers 140, the 3-D sound system may also contain auxiliary speaker 145 to project background sounds, other than the ambient sounds, associated with the environmental scene displayed on the video display screens. Typical background sounds include but are not limited to music, street noises, voices and the like, because these sounds typically do not move with the images of environmental scene, the auxiliary speakers 145 banks are positioned within the interior space and are not connected to any video display screen 135. For example, a beach environment may have the sound of Caribbean music playing in the background, or the sound of small children playing on the beach. The auxiliary speakers 145 output these background sounds to provide realism and further enhance the multimedia experience.

The computerized design system 100 may also contain one or more scent generators 150 to disseminate odors 125 associated with environmental scene. The location and number of scent generators 150 are determined by to provide adequate coverage of the interior space. The scent generators 150 utilize scent cartridges manufactured by Fragrance Systems SL of Javea, Alicante, Spain. The scent cartridges contain natural scents suspended in a ceramic matrix. When the ceramic matrix is heated, a portion of the scent is atomized into fine particulates and released into the air. The particulates may be released at specific time intervals to insure that the scent is constantly present in the interior space. Alternatively, the scent generators 150 may be programmed to release a particular scent in coordination with a particular scene displayed on the video display screens 135. For example, a beach scent may be released periodically when a beach scene is displayed on the video display screens 135. Similarly, a chocolate scent may be released to simulate the smell of a French pastry shop while displaying a scene of a Paris street on the video display screens.

The computerized design system 100 may also contain an enhanced lighting system 155 to control the lighting aspects of the environmental theme in the interior space. The enhanced lighting system 155 is anticipated to enhance and not replace the standard lighting within the interior space. For example, most retail stores are lit with standard fluorescent light fixtures, which are hard on the eyes and portray individuals in an unflattering manner. Furthermore, fluorescent lights are typically not the natural light of most environments. The enhanced lighting system 155 provides lighting effects that are associated with the environment scheme and enhance the overall lighting effect of the interior space. For example, an interior space portraying a beach scene may use lights that simulate natural sunlight, or wash a particular portion of the interior space with neon lights to further enhance the multimedia experience and the patrons overall enjoyment.

In addition to using computer-controlled multimedia systems, the computerized design system 100 may also use standard stage prop elements 160 to further enhance the environmental scheme created by the computer-controlled devices of the computerized design system 100. The stage prop elements 160 add to the realism projected in the interior space. Standard staged prop elements 160 may include, but are not limited to plants, trees, flowers, sand, rocks, furniture, pictures, draperies, and various knickknacks that accentuate the theme of the environment displayed on the visual display screen 135. In addition to inanimate elements, living biological specimens, such as birds and animals may be used to further add to the realism. The heavier stage prop elements 160 are placed on wheeled carts for easy movement around the interior space. Returning to the example of simulating a Caribbean beach, palm trees, tropical plants, sand, and tropical birds may be placed at predetermined locations around the interior space to further enhance the illusion of standing on a Caribbean beach.

Additionally each stage prop element 160 has a predetermined location within the interior space where it is located. Assigning predetermined locations within the interior space for each stage prop element 160, allows the stage prop elements 160 to be easily and quickly replaced with new stage prop elements 160 associated with a new environmental theme, thereby creating a whole new atmosphere in a short period of time.

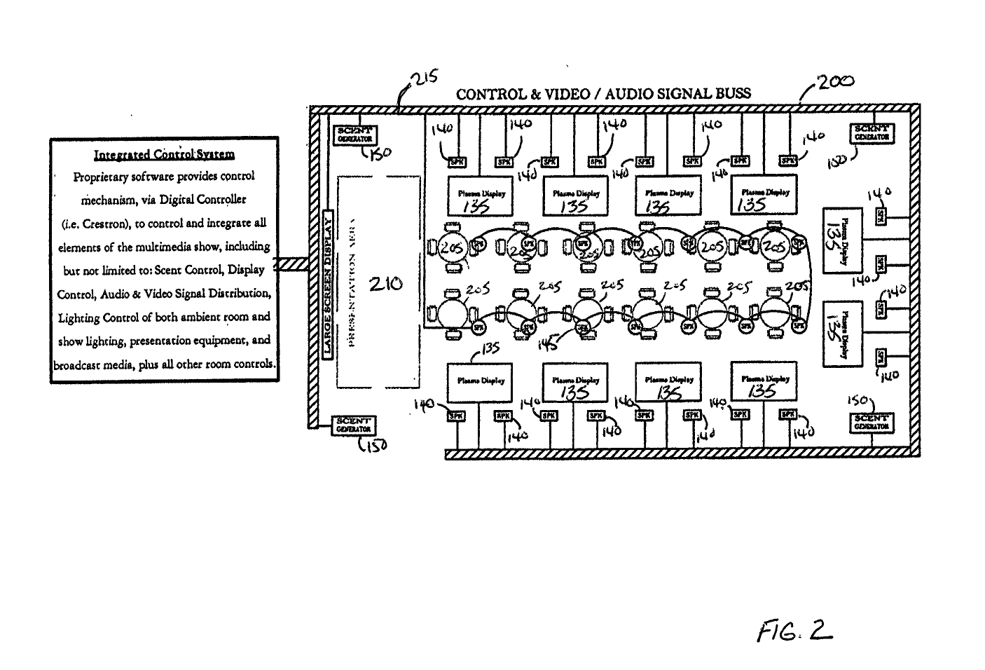

FIG. 2 is a schematic of an interior space 200 using the present invention. The schematic is illustrative of a restaurant using the computerized design system 100 to alter the appearance of the interior space 200. The interior space 200 contains tables and chairs 205 for seating customers within the central portion of the interior space 200. The restaurant also contains a presentation area 210 that may be used as a dance floor, stage, or the like. A number of plasma display screens 135 are located along three walls of the interior space to provide at least 270 degrees of coverage for the video images. Each plasma display screen 135 is separated from each adjacent plasma display screen by about eight feet. Additionally, each plasma display screen 135 may be recessed into the wall to provide the customers with the illusion that the plasma displays screens 135 are “windows” to an outside environment. To further enhance the feeling of “windows,” the plasma display screens 135 may be framed with the façade of a window, complete with window sash and glass panes.

Associated with each plasma display screen 135 are two primary speakers located on either side of the “window.” The primary speakers 140 project the ambient sounds associated with the environment displayed on the plasma display screens 135. In addition to the primary speakers 140, a bank of auxiliary speakers 145 are included in the interior space 200. In the present illustration, the auxiliary speakers 145 are located within the ceiling structure directly above the tables 205. The auxiliary speakers 145 are positioned within the interior space 200 to provide background sounds associated with the environment theme displayed on the plasma display screens 135. Because the auxiliary speakers 145 are positioned in the ceiling structure, there is not a direction associated with the music and the customers are “bathed” in the sounds so that they feel that the music is playing in the background and are not part of the ambient associated with the images being displayed on plasma display screens 135. The combination of the primary speaker 140 and the auxiliary speakers 145 provide a three-dimensional sound system that makes the customers feel that they are part of the environmental scene.

As an example, to create the feeling of Paris café, the video display screens 135 might display a street scene in Paris, France. To enhance the customer's sensation that they are really in a Paris café, the primary speakers 140 would play the ambient sounds associated with a Paris street, such as traffic noise, the sound of voices speaking French, and so on. The auxiliary speakers 145 may simultaneously play soft French music that one might typically hear in an actual caféin Paris. The combination of the directional ambient noise and the static background noise give the customer with the three dimensional sounds of a Paris café, thereby increasing the realism of the environment.

The computerized design system 100 also contains several scent generators 150 located in each of the four comers of the interior space 200. The scent generators 150 dispense an aroma associated with the images being displayed on the plasma displays 135 into the interior space. The scents may be released on at predefined intervals to insure that the scent is continually in the air or, alternatively, a particular scent may be released in connection with an event that occurs on the plasma display screens 135. For instance, in a Caribbean beach setting, it may not be desirable to continually dispense a scent that reminds customer of a tropical breeze. However, it is desirable to dispense a tropical breeze scent whenever a breeze is shown on the plasma display screen 135 as coming off the ocean. In this instance, a short time after an ocean breeze is shown on the plasma display screen 135, the scent generators may disperse the tropical breeze scent to present the illusion to the customers that they are actually on a Caribbean beach.

Each of the computer-controlled device that provide the multi-sensor experience are connected to a control and video/audio signal buss 215 that runs through the walls of the interior space 200. The control and video/audio signal buss 215 is connected to a central processing unit 105 (FIG. 1), which contains an integrated control system. The integrated control system provides a control mechanism to integrate and coordinate all elements of the multimedia show, including the plasma display screens 135, the primary speakers 140, the auxiliary speakers 145, the scent generators 150, and the enhanced lighting system 160 (not shown).

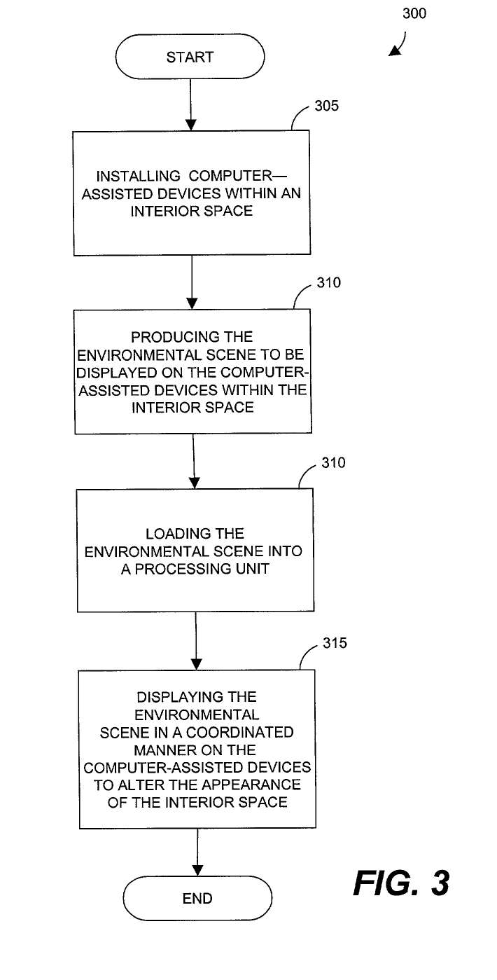

FIG. 3 is a logic flow diagram illustrating a method 300 for electronically altering the appearance of an interior space, such as a restaurant. The method 300 begins at 305, in which the computer-assisted devices, which include but not limited to video display screens 135, primary speakers 140, auxiliary speakers 145, scent generators 150, and an enhance lighting system 155, are installed within the interior space. Typically, the interior space is measured and acoustical measurements are taken to determine the acoustical properties of the interior space. Once the appropriate measurements are completed, a design of the interior space is produced to determine the location of the computer-assisted devices. Typically, when designing the layout for the interior space, it is desirable to position the video display screens 135 around the interior space to provide about 270 degrees of coverage. Another consideration to consider when designing the layout for the video display screens 135 is that the video display screens 135 are simulating windows. Therefore, a good layout is to incorporate the building regulation for the placement of windows along an outside wall of a building. Typically, the building regulations suggest that windows be place approximately eight feet apart. Therefore, the initial layout of the interior space should place the video display screens 135 every eight feet along a given wall. Placing the video display screens 135 eight feet apart is intended to be a guide. The shape of the interior space, the size of the video screens 135 any obstructions, such as pipes and the like on the wall must be taken into consideration when designing the layout. Therefore, the video display screens 135 may be placed more than eight feet apart or less than eight feet apart to achieve the most desirable effect.

Next, the configuration of the audio system is laid out. Usually, there are two primary speakers 140 positioned proximate to each video display device 135 to provide the ambient sounds associated with the images displayed on the video display device 135. In a typical configuration, there is one primary speaker on each side of the video display screen 135. As the movement of the video images move from one video display screen 135 to another, the ambient sound is coordinated to move with the image and be outputted over the appropriate pair of primary speakers 140 to provide the feeling of movement within the video image. The use of a pair of primary speakers 140 for each video display device 135 is intended to be a starting point for the designer. The designer may add or remove the primary speakers 140 to achieve a desired effect based on the acoustical measurements of the interior space.

The designer then arranges the auxiliary speakers 145 within the interior space to provide the background sounds with the aim to “bathe” the space in sound. Because the auxiliary speakers 145 play background sounds, the design goal is to create the feeling that the sounds are coming from every direction. Again, the number and location of the auxiliary speakers 145 will depend on the acoustical measurements of the interior space.

Next, the lighting elements 155 are arranged in the interior space to provide uniform coverage of the interior space. Any additional accent lighting is also added at this time. The lighting elements 155 are typically theater lights that can accept a variety of filters to produce different lighting conditions. Finally, the scent generators 150 are positioned to provide complete coverage of the interior space.

At 310, the environmental scene is produced. Typically the environmental scene consists of video images and audio image data of a particular environment, such as a Caribbean beach, a European village, an English countryside viewed from a train, and the like. The video images used for the computerized design system 100 are different than the typical video images. Normal video images are taken while the camera is moving to convey a feeling of motion. The video images taken for the computerized design system 100 are taken while a digital camera is rigidly fixed in a single location. This technique is known as “lock-down ” photography and is a well-known technique used for time-lapsed photography. The camera is positioned and focused on a particular object or point in space and a succession of discrete images are captured over a given time period. Although the technique is the same, the time interval between images in time-lapsed photography is much greater than the time interval between images obtained for the computerized design system 100. The shorter time interval between discrete images used for the computerized design system 100 allows the images, when viewed in succession, to appear as a continuous motion. The length of time that the video images are recorded may vary from a few hours to 24 hours, depending on requirements of the particular production and how the final video images will be used in the computerized design system 100.

While the video images of the environmental scenes are being recorded, the ambient noises are simultaneously being digitally recorded. The background sounds that will be played over the auxiliary speakers 145 are typically not recorded at this time, because the background sounds are not distinctly associated with the environmental scene. The background sounds, such as music, people voices, traffic sounds, and the like can be recorded at a later time in recording studio from library of digitally recorded sounds. However, if there is particular background sound that is unique to the environment, such as a particular Caribbean band at the beach, these background sounds may be recorded at the same time as the ambient sounds to provide greater realism to the experience. Once all the video images and sounds are recorded they are stored in a central database located on a central server, where they are combined to produce the final environmental scene.

At 315, the environmental scene is loaded into the processing unit 105 of the computerized design system 100 located at the interior space. The central processing unit 105 at the computerized designs system 100 accesses the central database at the central server over a distributed network, such as the Internet using standard compression techniques. Once the central processing unit 105 accesses the central server, the file containing the environmental scene can be downloaded to the central processing unit 105. The central processing unit then combines the video signals, the audio signals and creates a multimedia presentation. The multimedia presentation carries an encoded timing signal that set the time parameters that coordinate the video images, audio signals, enhanced lighting, and the release of particular scents at particular times during the multimedia presentation. The multimedia presentation is then passed through a programmable digital controller, which decodes the timing signal, displays the video images on the video display screens and triggers the appropriate device at the appropriate time during the multimedia presentation that alters the appearance of interior space.

It should be understood that the foregoing pertains only to the preferred embodiments of the present invention, and that numerous changes may be made to the embodiments described herein without departing from the spirit and scope of the invention.

I claim:

1. A system for altering the appearance of an interior space, comprising:
a plurality of computer-controlled devices comprising:
a plurality of video display screens arranged about the interior space for displaying a plurality of video images received from a central processing unit;
a plurality of speakers associated and placed proximate to the video display screens for electronically playing a plurality of audio inputs received from the central processing unit, wherein the audio inputs replicate ambient sounds associated with the video images; and
a scent generator placed within the interior space for dispensing a scent in response to receiving a signal from the central processing unit, the scent being associated with at least one video image displayed on the plurality of video display screens; and
a central processing unit operable to control and coordinate the operation of the computer-controlled devices to alter the appearance of the interior space.

2. The system of claim 1, further comprising a plurality of auxiliary speakers for playing a plurality of background sounds, wherein the complementary sounds are associated with the video images.

3. The system of claim 1, wherein the video display screens are positioned within the interior space to provide at least 270 degrees of coverage.

4. The system of claim 1, wherein the video display screens are separated from one another by about eight feet.

5. The system of claim 1, wherein the video display screens are high definition plasma display screens.

6. The system of claim 1, wherein the video signals displayed on the plurality of video display screens comprises digital images of environmental scenes.

7. The system of claim 6, wherein the digital images of environmental scenes displayed on the plurality of digital display screens are coordinated.

8. The system of claim 1, wherein the audio signals comprise digital representations of sounds associated with the environmental scenes and is coordinated with the video signal.

9. A system for altering the appearance of an interior space, comprising:
a plurality of plasma display screens spaced apart from one another around the interior space;
a plurality of primary speakers, wherein at least two primary speakers are positioned proximate to each one of the plurality of plasma display screens; and
a central processing unit comprising:
a storage device for storing
a plurality of video images depicting a plurality of environmental scenes; and
a plurality of audio data that replicate the sounds associated with the plurality of environmental scenes;
wherein the video images are transmitted to the plurality of plasma display devices such that each video images are coordinated with every other video image displayed on every other plasma display screen to produce the environmental scene, and
wherein the audio data associated with a particular video image displayed on a particular plasma display screen is transmitted to the at least two speakers place proximate to the plasma display screen.

10. The system of claim 9, further comprising a scent generator to distribute a scent within the interior space, the scent being associated with the environmental scene.

11. The system of claim 9, further comprising a plurality of auxiliary speakers arranged within the interior space to play a complementary audio signal associated with the environmental scene.

12. The system of claim 9, wherein the central processing unit further comprises:
a digital controller for coordinating the display of video images and the playing of audio images to present and the dispensing of the scent.

13. The system of claim 9, wherein the plasma display screens are arranged within the interior space such that each plasma display is separated form every other plasma display screen by about eight feet.

14. The system of claim 13, further comprising a plurality of theatrical props arranged within the interior space, the theatrical props being associated with the environmental scene displayed on the plurality of plasma display screens.

15. A method of altering the appearance of an interior space by electronically displaying an environmental scene, comprising:
installing a plurality of computer-assisted devices within the interior space, to electronically present the environmental scene, the computer-assisted devices comprising;
a plurality of video display screens;
a plurality of speakers placed proximate to the video display screens;
a plurality of lighting elements; and
a scent generator to dispense a scent associated with the environmental scene;
producing the environmental scene, comprising:
capturing video images associated with the environmental scene; and
recording audio data associated with the environmental scene; and
loading the video images and audio data associated with the environmental scene into a processing unit; and
displaying the video images on the plurality of video display screens and playing the audio data on the plurality of primary speakers in a coordinated scheme
changing an interior space by providing movable elements comprising design elements, and providing computer-assisted devices.
